(19) United States
(12) Patent Application Publication
(10) Pub. No.: US 2017/0346109 A1
(43) Pub. Date: Nov. 30, 2017

(54) Cooling System for at Least One Fuel Cell of a Fuel Cell System and Method for Cooling at Least One Fuel Cell

(71) Applicant: Bayerische Motoren Werke Aktiengesellschaft, Muenchen (DE)

(72) Inventors: Volker Formanski, Ismaning (DE); Gustavo Rizo Patron, Muenchen (DE)

(21) Appl. No.: 15/677,464

(22) Filed: Aug. 15, 2017

Related U.S. Application Data
(63) Continuation of application No. PCT/EP2016/051791, filed on Feb. 16, 2015.

(30) Foreign Application Priority Data
Feb. 16, 2015 (DE) 102015202778.3

(51) Int. Cl. H01M 8/04029; H01M 8/04223; H01M 8/04746; H01M 8/0432

(52) U.S. Cl. CPC H01M 8/04029; H01M 8/04768; H01M 8/04268; H01M 8/0432

(57) ABSTRACT

A cooling system for a fuel cell of a fuel cell system includes a cooling circuit that includes at least one heat exchanger and the fuel cell. The cooling system also includes at least two pumping devices, arranged in the cooling circuit, whereby the at least two pumping devices at least sometimes jointly deliver coolant into the cooling circuit.

### CROSS REFERENCE TO RELATED APPLICATIONS

This application is a continuation of PCT International Application No. PCT/EP2016/051791, filed Jan. 28, 2016, which claims priority under 35 U.S.C. §119 from German Patent Application No. 10 2015 202 778.3, filed Feb. 16, 2015, the entire disclosures of which are herein expressly incorporated by reference.

### BACKGROUND AND SUMMARY OF THE INVENTION

The technology disclosed herein relates to a cooling system for at least one fuel cell of a fuel cell system and to a method for cooling at least one fuel cell.

Fuel cell systems for mobile applications such as motor vehicles are known from the prior art. In its simplest form, a fuel cell is an electrochemical energy converter, which converts fuel and oxidizing agent into reaction products and in the process produces electricity and heat. In such a fuel cell, for example hydrogen is used as fuel and air or oxygen as oxidizing agent. The reaction product of the reaction in the fuel cell is for example water. Here, the gases are fed into corresponding diffusion electrodes which are separated from one another by a solid or liquid electrolyte.

During the operation of fuel cells, the cold start (start at an ambient temperature of 0° C. to 25° C.) and the frost start (start with an ambient temperature below 0° C.) are particularly affected by problems. At low temperatures, for example, the molecules of the catholyte and the ions traversing the separator have comparatively low kinetics. This results in the polarization curves during a cold start having lower voltages than during a warm start. Consequently, the fuel cell system can be operated less efficiently at low temperatures. For this reason there is a need for bringing the fuel cell system up to an operating temperature as quickly as possible, at which the system has a better efficiency.

From DE 11 2006 001 348 B4 a cooling circuit with a heat exchanger and a fuel cell is known. A pump delivers the coolant through the circuit. During the warming-up phase of the fuel cell, a heat exchanger bypass is activated via a three-way valve in such a manner that during the warming-up phase the coolant does not flow through the heat exchanger. This measure serves to more quickly warm up the fuel cell.

The fuel cells operate at comparatively low temperatures of approximately 80° C. to 90° C. For cooling, comparatively high volumetric flows of several thousand litres per hour therefore have to circulate between the fuel cells and the heat exchanger. For this reason, comparatively high-performance high-voltage pumps are employed. Because of their power requirement, these high-voltage pumps cannot be supplied via the 12V vehicle electrical system. These require higher voltages so that they can provide the required pressure differential even at high volumetric flows. Such high-voltage pumps are not installed in conventional vehicles to date. Comparatively favorable and automotive-tested 12V pumps, which are supplied with current via the vehicle electrical system, cannot be used.

Three-way valves as such are known from non-automotive applications. Because of the high volumetric flows and the limited installation space, commercially available three-way valves cannot be employed in the motor vehicle. Complex and thus comparatively expensive special solutions are rather necessary. Consequently, with the cooling concepts known to date, comparatively expensive special components are therefore employed which significantly increase both the manufacturing costs and also the service and storage costs.

It is an object of the technology disclosed here to reduce or remedy the disadvantages of the known solutions. In particular it is an object of the technology disclosed here to quickly and efficiently bring a fuel cell up to its operating temperature. It is an object of the technology disclosed here, furthermore, to lower the costs for the required components and employ simpler and fewer components at the same time, which can preferably be operated with the vehicle electrical system voltage present in the vehicle. The endeavor, furthermore, is to further reduce the failure probability.

The technology disclosed here relates to a cooling system for a fuel cell of a fuel cell system, in particular for mobile applications such as for example motor vehicles. A fuel cell system according to the technology disclosed here can comprise at least one fuel cell and the peripheral system components (balance of plant components or BOP components), which can be employed during the operation of the at least one fuel cell. A fuel cell comprises an anode and a cathode, which are separated in particular by an ion-selective separator. The anode has a feed for a fuel to the anode. In other words, the anode, during the operation of the fuel cell system, is fluidically connected to a fuel reservoir. Preferred fuels for the fuel cell system are: hydrogen, low-molecular alcohol, bio fuels or liquefied natural gas. The cathode, for example, comprises a feed for oxidizing agent. Preferred oxidizing agents are for example air, oxygen and peroxides. The ion-selective separator can for example be designed as a proton exchange membrane (PEM). Preferably, a cation-selective polymer electrolyte membrane is employed. Materials for such a membrane are: Nafion®, Flemion® and Aciplex®. For the purposes of simplification, a system with a fuel cell is often discussed.

The cooling system comprises at least one cooling circuit. The cooling circuit comprises at least one heat exchanger and the at least one fuel cell. Here, the fuel cells can be combined into a fuel cell stack, through which the coolant flows. The at least one heat exchanger is for example a cooler through which air flows and which can be supported by a fan. The cooling circuit is designed in such a manner that coolant can circulate between the heat exchanger and the at least one fuel cell. In other words, the coolant heated in the fuel cell can flow from the at least one fuel cell into the at least one heat exchanger, where it then cools down before it subsequently again flows into the at least one fuel cell.

Even if the word coolant is used here, this coolant is not only limited to cooling. On the contrary, the coolant can also be used for warming up or generally for temperature-controlling the at least one fuel cell. Preferably, water with suitable additives is employed as coolant. Preferably, the cooling system serves for the equal heat distribution, i.e. the avoidance of higher temperature gradients, within the fuel cells or within the fuel cell stack.

The cooling system, furthermore, comprises at least two pumping devices, which are likewise part of the cooling circuit. The pumping devices are thus arranged in the cooling circuit and designed, at least part of the time, to jointly deliver or circulate the coolant in the cooling circuit, i.e. between the at least one fuel cell and the at least one heat exchanger. Preferably, the at least two pumping devices jointly deliver or circulate the coolant, at least during a cooling phase or normal operating phase of the fuel cells.

When at least two pumping devices are employed, these pumping devices can be dimensioned smaller than a single pumping device. In particular, the at least two pumping devices can be dimensioned in such a manner that they can be connected to the vehicle electrical system of the vehicle (e.g. 12V vehicle electrical system). When the pumps can be connected to the vehicle electrical system, further components for voltage conversion to a voltage that is higher than the vehicle electrical system voltage can be omitted. Furthermore, already tested and used pumping devices can be employed. This has a particularly positive effect on the manufacturing and service costs and to the failure safety. In principle, a wide range of pumps can serve as a pumping device, for example a non-return valve pump, as already installed in the automotive sector.

Further preferably, two same pumping devices are employed. Preferably, both pumps are embodied identical in design so that the part variance drops further.

Preferably, the first pumping device is provided upstream of the fuel cell and downstream of the heat exchanger. Further preferably, the second pumping device can be provided downstream of the fuel cell and upstream of the heat exchanger. Accordingly, the pressure losses can be favorably distributed over the two devices. The fuel cells constitute the greatest flow resistance. When the pumping devices are arranged (directly) in front of and after the fuel cells, an advantageous pressure profile in the cooling circuit materializes.

Preferably, the cooling circuit furthermore comprises a bypass which branches off at a branch-off a fuel cell discharge line downstream of the at least one fuel cell and upstream of the at least one heat exchanger. The bypass opens into a mouth in a fuel cell feed line upstream of the at least one fuel cell and downstream of the at least one heat exchanger. The fuel cell discharge line in this case is the flow path through which the coolant leaving the fuel cell flows in order to get to the heat exchanger. The fuel cell feed line is the flow path through which the coolant flows when it flows from the heat exchanger to the fuel cell.

With the bypass it is possible to realize a sub-cooling circuit excluding the heat exchanger. It is advantageous, for example, to prevent the fluid during the warming-up phase of the fuel cell system from circulating through the heat exchanger. As a result, the quantity of coolant that has be heated for warming up the fuel cell during the warming-up phase is reduced. It is prevented, furthermore that the coolant to be heated up during the warming-up phase again cools down in the heat exchanger. The warming-up phase in this case is the phase in which the fuel cell system of the motor vehicle is warmed up to the (optimal) operating temperature. The warming-up phase commences with the activation of the fuel cell system and ends with the reaching of the operating temperature, from which the drive operation of the motor vehicle is permitted by the vehicle or a control. Particularly preferably, the warming-up phase of the fuel cell is activated even before the actuation of the ignition key or the starter button. For example, the warming-up phase can be initiated by a radio signal or by a timer. In a configuration, the vehicle driver can start the warming-up of the fuel cell system for example via suitable software of a mobile telephone. Alternatively, the warming-up phase can commence with the signal for unlocking the central locking system.

The first pumping device can be arranged upstream of the at least one fuel cell and downstream of the mouth of the bypass in the fuel cell feed line. The second pumping device can be arranged in the fuel cell discharge line downstream of the branch-off of the bypass and upstream of the at least one heat exchanger. With such an arrangement of the at least two pumping devices it is possible that during the warming-up phase merely the first pumping device has to be switched on. Compared with the high-voltage pumps, this pump is smaller and moreover operates in an operating point with better efficiency. Accordingly, the energy consumption during the warming-up phase can be reduced.

Particularly preferably, the cooling system furthermore comprises a feed line valve, which can be arranged in the fuel cell feed line upstream of the fuel cell, in particular upstream of the mouth of the bypass, and downstream of the at least one heat exchanger. Further preferably, a bypass valve can be arranged in the bypass. Preferably, the feed line valve and/or the bypass valve can be designed as non-return valves or stop valves, in particular as throttle valves. In particular, the feed line can be designed in such a manner that during the warming-up phase it reduces or prevents a coolant flow through the heat exchanger. The bypass valve can be designed in such a manner that it can prevent a return flow from the mouth of the bypass to the branch-off of the bypass.

The technology disclosed here comprises, furthermore, a method for cooling the at least one fuel cell of the fuel cell system or cooling system shown here. During a warming-up phase of the at least one fuel cell, coolant is delivered by the first pumping device. At the same time, the second pumping device will deliver substantially no or no coolant at all to the heat exchanger. Furthermore, the feed line valve is closed at the same time. Accordingly, it is ensured with simple means that during the warming-up phase merely the coolant flows from the at least one fuel cell via the bypass back to the fuel cell without the fluid circulating via the heat exchanger. Here, substantially no coolant comprises minor negligible unintentional or tolerable delivery flows of the second pumping device, which influence the warming-up time only to a minor or negligible degree. Optionally, at least one temperature control or heating device is provided in the bypass, which during the warming-up phase warms up the coolant and thus the fuel cells.

The first pumping device can at least at times, preferably continuously, generate a greater suction pressure than the second pumping device during a cooling or operating phase of the fuel cell following the warming-up phase, in particular in such a manner that during the cooling or operating phase only minor quantities of cooled coolant get directly from the heat exchanger via the bypass and back again into the heat exchanger. With this configuration it is advantageously possible, furthermore, to entirely omit the bypass valve in the bypass. Preferably, no bypass valve is thus arranged in the bypass. This further reduces the manufacturing costs and further reduces the failure probability.

According to a particularly preferred method, two same or same-designed pumping devices are employed. Preferably, the same pumping devices are operated at different rotational speeds. Particularly preferably, the first pumping device is operated with a higher rotational speed than the second pumping device. In particular, the first pumping device is operated with a rotational speed that is higher in such a manner that the first pumping device builds up an adequately greater suction pressure than the second pumping device, so that during a cooling or operating phase only minor or no quantities of cooled coolant flow via the bypass back to the heat exchanger.

The technology disclosed here furthermore relates to a fuel cell system with the cooling system for a fuel cell disclosed here.

The technology disclosed here is now described by way of the figures. There:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a coolant circuit according to the prior art, and

FIGS. 2-4 show one or more embodiments of a cooling system according to the technology disclosed herein.

### DETAILED DESCRIPTION OF THE DRAWINGS

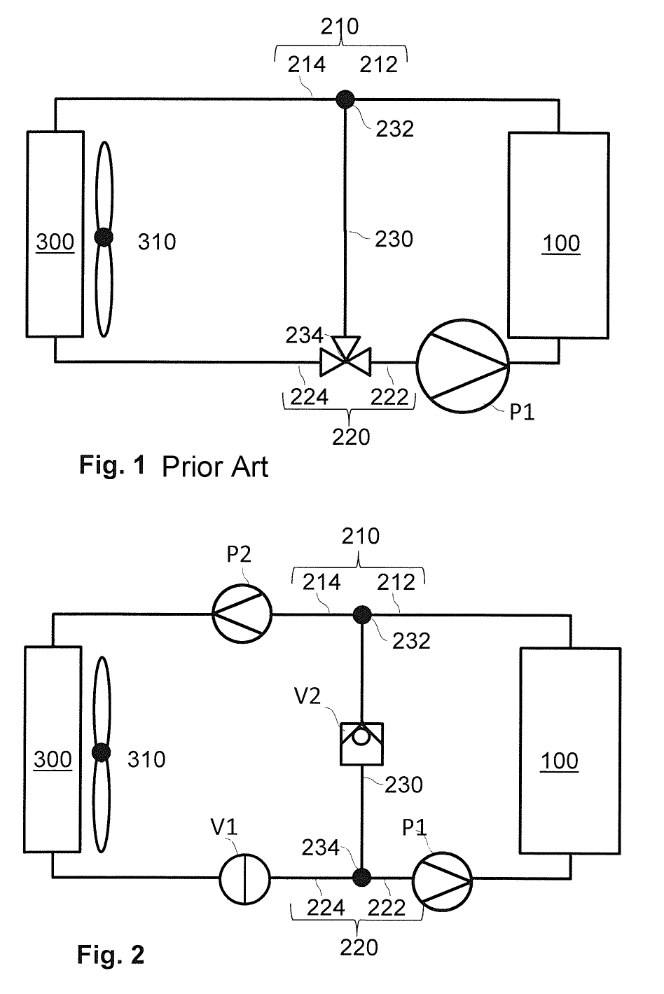

FIG. 1 shows a cooling system as shown in DE 11 2006 001 348 B4. The cooling system comprises a cooling circuit 210, 220 with a cooler 300, which can be supported by a fan 310, and fuel cells of a fuel cell system which are combined into a fuel cell stack. In the feed line 220, the pumping device P1 is arranged between the three-way valve 234 and the fuel cell stack. The pumping device P1 is designed in such a manner that it can provide adequate coolant both during the warming-up phase and also during the normal cooling or operating phase. Because of the low operating temperature of the fuel cell 100, a comparatively powerful pumping device is necessary, which is operated with a voltage above the vehicle electrical system voltage. During the warming-up phase, the three-way valve closes the flow path 224 and makes possible a bypass flow via the flow paths 212, 230 and 222.

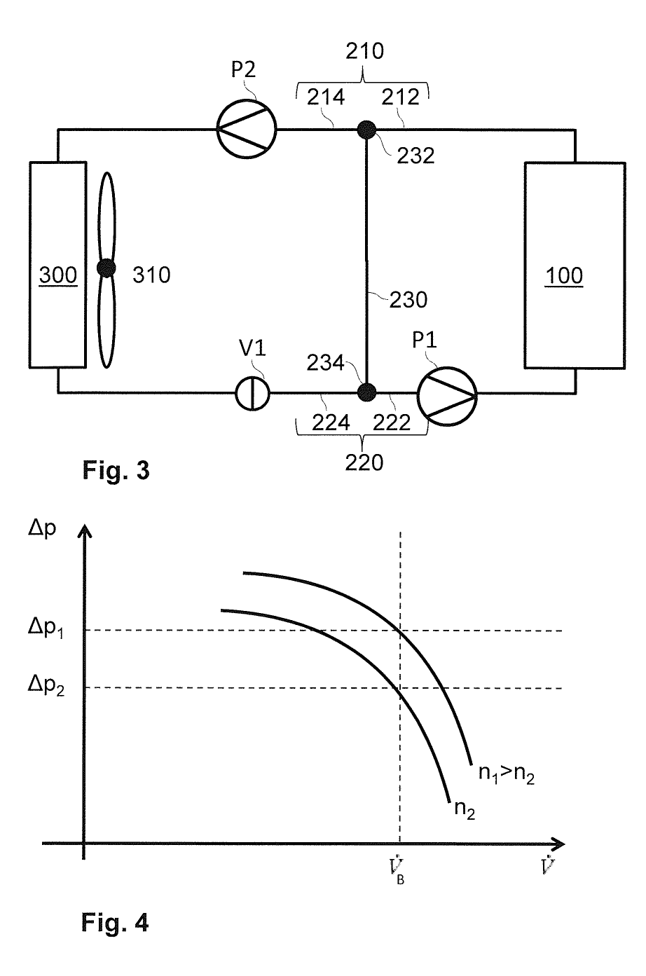

FIG. 2 shows a cooling system according to the technology disclosed here and two same pumps P1, P2 are provided here in the cooling circuit 210, 220. The first pumping device P1 is located in the flow path 222 between the fuel cell stack comprising at least one fuel cell 100 and the mouth 234 of the bypass 230. The second pumping device P2 of identical design is arranged in the flow path 214, which connects the branch-off 232 of the bypass 230 with the heat exchanger 300. In the bypass 230, the non-return valve or bypass valve V2 is arranged. The non-return valve V2 is configured so that it allows a coolant flow from the branch-off 232 to pass through to the mouth 234, whereas it blocks this in the opposite direction.

Furthermore, a feed line valve V1 is provided in the flow path 224 in the configuration shown here. The flow path 224 connects the heat exchanger 300 with the mouth 234 of the bypass 230. The shut-off valve V1 prevents, in the closed state, a coolant flow through the heat exchanger 300. The coolant then flows out of the fuel cell stack 100 via the flow path 212 into the bypass 230 and the pumping device P1 sucks the coolant out of the bypass 230 and delivers it to the fuel cell 100 via the flow path 222.

Not shown in the FIGS. 1 to 3 is the heat exchanger or the heating device, which during the warming-up phase warms up the coolant and ultimately the fuel cell 100. During the cooling or operating phase, the pumping device P2 delivers the coolant to the cooler 300. In the cooler 300, the coolant cools down before it is again delivered into the fuel cell via the feed line 220. The two pumping devices P1, P2 are connected in series here and together provide the necessary pumping performance in order to deliver the necessary pressure stroke and the necessary volumetric flow. Each pumping device P1, P2 on its own has to provide less performance than the pumping device according to the prior art, (see FIG. 1).

As shown in FIG. 3, the bypass valve V2 can also be omitted when for example the pumping devices P1, P2 are activated in such a manner that in the cooling or operating phase of the at least one fuel cell 100, no or only insignificant quantities of coolant flow from the feed line 220 into the discharge line 210 via the bypass 230. This can be achieved for example in that during a cooling or operating phase of the at least one fuel cell 100 the first pumping device P1 generates a greater suction pressure Δp1 than the second pumping device P2.

As shown in FIG. 4, different suction pressures Δp1, Δp2 can be generated for two pumps P1, P2 of identical design, in that the pumps P1, P2 of identical design are operated at different rotational speeds n1, n2. When for example the pump P1 is operated at the rotational speed n1, a greater suction pressure Δp1 is obtained for a constant volumetric flow than for the second pumping device P2 which is operated at a lower rotational speed n2 with the same volumetric flow. The two pumping devices P1, P2 are connected in series. Because of the greater suction pressure Δp1 of the first pumping device P1, no coolant flows through the bypass 230. Consequently, the volumetric flows, which flow through the two pumping devices P1, P2 are approximately identical. The feed line valve V1 shown here can be embodied for example as shut-off valve V1 (see FIG. 2).

With the technology disclosed here, comparatively expensive three-way valves can be omitted. In its place, comparatively simple and cost-effective valves are employed. Altogether, the manufacturing and service costs can be further lowered by way of the technology disclosed here.

Provided the technology disclosed here was disclosed in the singular, the plurality shall also be encompassed at the same time. If for example a fuel cell or a heat exchanger is discussed, their plurality shall also be included at the same time. The preceding description of the present invention only serves for illustration purposes and not for the purpose of restricting the invention. Within the scope of the invention, various changes and modifications are possible without leaving the scope of the invention and their equivalents.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A cooling system for a fuel cell of a fuel cell system, the cooling system comprising:
a cooling circuit that includes at least one heat exchanger and the fuel cell; and
at least two pumping devices, arranged in the cooling circuit, wherein the at least two pumping devices at least sometimes jointly deliver coolant into the cooling circuit.

2. The cooling system as claimed in claim 1, wherein the at least two pumping devices comprises a first pumping device that is provided upstream of the fuel cell and downstream of the heat exchanger, and a second pumping device that is provided downstream of the least one fuel cell and upstream of the heat exchanger.

3. The cooling system as claimed in claim 1, wherein the at least two pumping devices are identical in design.

4. The cooling system as claimed in claim 1, wherein the cooling circuit further comprises a bypass that branches off of a fuel cell discharge line downstream of the fuel cell and upstream of the heat exchanger, and wherein the bypass opens in a fuel cell feed line upstream of the fuel cell and downstream of the heat exchanger.

5. The cooling system as claimed in claim 2, wherein the cooling circuit further comprises a bypass that branches off of a fuel cell discharge line downstream of the fuel cell and upstream of the heat exchanger, and wherein the bypass opens in a fuel cell feed line upstream of the fuel cell and downstream of the heat exchanger.

6. The cooling system as claimed in claim 4, wherein the first pumping device is arranged upstream of the fuel cell and downstream of the mouth of the bypass, and wherein the second pumping device is arranged downstream of the branch-off of the bypass and upstream of the heat exchanger.

7. The cooling system as claimed in claim 5, wherein the first pumping device is arranged upstream of the fuel cell and downstream of the mouth of the bypass, and wherein the second pumping device is arranged downstream of the branch-off of the bypass and upstream of the heat exchanger.

8. The cooling system as claimed in claim 4, further comprising a feed line valve arranged in the fuel cell feed line upstream of the first pumping device in a mouth of the bypass.

9. The cooling system as claimed in claim 4, wherein a bypass valve is arranged in the bypass.

10. The cooling system as claimed in claim 6, further comprising a feed line valve arranged in the fuel cell feed line upstream of the first pumping device in a mouth of the bypass.

11. The cooling system as claimed in claim 6, wherein a bypass valve is arranged in the bypass.

12. A method for cooling a fuel cell of a fuel cell system with a cooling system having a cooling circuit comprising at least one heat exchanger and the fuel cell, and wherein the cooling system also comprises a first pumping device and a second pumping device arranged in the cooling circuit, wherein the first and second pumping devices at least sometimes jointly deliver coolant into the cooling circuit, the method comprising the acts of:
delivering, in a warming-up phase of the fuel cell, cooling liquid by the first pumping device, wherein the second pumping device at the same time delivers substantially no cooling liquid, and wherein at the same time the feed line valve is closed.

13. The method as claimed in claim 12, generating, by the first pumping device during an operating phase of the fuel cell, a greater suction pressure than the second pumping device.

14. The method as claimed in claim 12, wherein the first and second pumping devices are operated at different rotational speeds, and wherein the first pumping device is operated at a higher rotational speed than the second pumping device.

15. The method as claimed in claim 13, wherein the first and second pumping devices are operated at different rotational speeds, and wherein the first pumping device is operated at a higher rotational speed than the second pumping device.
